(19) United States
(12) Patent Application Publication
(10) Pub. No.: US 2006/0184422 A1
(43) Pub. Date: Aug. 17, 2006

(54) Method and apparatus for accessing transaction data in a travel settlement system using a graphical user interface

(76) Inventors: Sandy Cooper, Evergreen, CO (US); Mark Diskin, Tampa, FL (US); Mike Dubois, Tampa, FL (US); Kim McCall, Tampa, FL (US); Wayne Polk, Riverview, FL (US); Sadanand Kusma, Tampa, FL (US); Pardeep Kumar, Tampa, FL (US); Lucianne Leighton, St. Petersburg, FL (US); Lorna Russell, Temple Terrace, FL (US); Phil Myers, Valrico, FL (US)

Correspondence Address: Blaney Harper;JONES DAY, 51 Louisiana Avenue, NW, Washington, DC, 20001-2113, US

(21) Appl. No.: 11/059,516

(22) Filed: Feb. 17, 2005

(51) Int. Cl. G06Q 99/00; G06Q 20/00

(52) U.S. Cl. 705/16; 705/1

(57) ABSTRACT

A computer-implemented method of processing transaction data relating to settlement of travel transactions that utilizes a graphical user interface is described. A user of a travel-agency computer system enters data corresponding to a financial transaction relating to travel using the graphical user interface, and the travel-agency computer system communicates corresponding information to a computer system of a travel settlement entity via a network. The computer system of the travel settlement entity retrieves corresponding data from a database and processes the data. The travel settlement entity sends a communication to the travel agency via the network based upon the processed data.

### TECHNICAL FIELD

This invention relates to a method and apparatus for communicating financial transactions for travel using a secure travel service information system and, more particularly, a method and apparatus employing a graphical user interface that allows communicating financial transactions, managing users of the system, and accessing from the system a summary of financial transaction records and their supporting documents.

### BACKGROUND

Domestic and foreign air carriers, (e.g., American Airlines, Continental Airlines, Delta, British Airways, etc.) sell tickets directly to consumers. Travel agencies also sell tickets to consumers. That is, travel agencies assist consumers with their travel plans by making reservations on air carriers and ticketing those reservations. Travel agencies may also assist consumers by making reservations and issuing tickets on ground carriers (e.g., railroads and buses). Thus, the term “travel carrier” shall include both air and ground carriers as well as any type of transportation provider.

Travel agencies issue to passengers paper tickets, coupons and/or electronic tickets all of which are redeemable for travel. Travel agencies settle various financial transactions between travel carriers and travelers. Airlines Reporting Corporation (“ARC”) operates an accreditation program on behalf of participating air and rail carriers. ARC accredits Agents that sell tickets to the general public. ARC also accredits Corporate Travel Departments (“CTDs”) which may purchase tickets for their employees and representatives. “Agents” and “CTDs” are hereinafter referred to collectively as travel agencies.

Travel agencies accredited by ARC report, remit and settle such financial transactions through ARC. An organization that provides financial settlement services to the travel industry is referred to herein as a “travel settlement entity.” ARC is an example of a travel settlement entity, and ARC provides other services as well, including but not limited to data/document warehousing and retrieval. ARC administers the “Standard Ticket and Area Settlement Plan” (herein referred to as the “ASP”). The ASP was developed to process the reporting and settlement of transactions issued by accredited travel agencies on behalf of ARC participating travel carriers. The ASP processes the sales and remittances for approximately 22,000 authorized travel agency locations in the U.S., Puerto Rico and the U.S. Virgin Islands. Elements of the ASP include: standard traffic documents; one step imprinting on documents of the issuing travel carrier's name and the travel agent's validation at the time the document is issued; a consolidated sales report and single-sum remittance for all travel carriers to ARC, acting as a clearing house, to determine the amount due each travel carrier and transmit such amounts to the travel carrier; computer generated sales summaries for each agent and travel carrier for their respective sales activity; and remitting to the travel agent, any appropriate remittance.

Historically, travel agencies have used (and some still use) a manual system of recording, maintaining and processing travel transaction and financial settlement information. Such a manual recording system is extremely inefficient.

In addition to having a need to access financial settlement information relating to travel transactions, travel agencies and the travel settlement entity also have a need to access documentation. For example, there may be a need to access sales reports and supporting documentation, which may include, for example, the following: Ticket; Agent Automated Deduction (AAD); Agent Coupon (AGT); Authority to Refund a PTA transaction (ARP); Auditor Coupon (AUD); Type A certificate (CER); Companion coupon (CMP); Conjunction coupon (CNJ); Coupon returned in a refund or exchange (CPN); Credit memo (CRM); Debit memo (DBM); Carrier non-transport document (NTR); Recall Commission Statement (RCC); Refund Exchange Notice (REN); Regenerated Stock Control Number (RSN); Unapplied Void Transaction (UAV); Type B voucher (VOU); a Miscellaneous Charge Order (MCO) and other supporting documents.

Most travel agencies store sales reports and supporting documentation in “hard copy” paper form, which can be cumbersome and inefficient. Other travel agencies store the sales reports and supporting documents on microfiche, microfilm or some other optical storage medium, such as a CD-ROM, an optical disk, a DVD or a laserdisc. When the sales reports are stored on an optical storage medium, the sales reports are stored as document images. Although optical storage devices can store more sales reports in a given amount of physical space in comparison to hard copies of such reports, document images of the reports consume a fair amount of memory. Nevertheless, both the hard copy and optically stored sales reports and supporting documents are typically stored at the respective agency's location.

There are times when the validating travel carrier or ARC may wish to see or inspect the supporting documentation. Therefore, travel agencies are required to ensure that the stored copies of the sales reports and the supporting documents are accessible to ARC and the travel carriers. However, because the supporting documents are typically stored at the travel agent's location, it may be difficult and time consuming for the travel carrier and/or ARC to obtain a copy of the supporting document(s). Furthermore, it may be difficult for the travel agent, ARC and the validating travel carrier to search and locate the requested documentation.

The present inventors have observed a need for a user-friendly financial information and settlement system that allows a travel agent and ARC to conveniently carry out desired financial transaction(s).

The present inventors have also observed that it would be desirable to provide convenient access to such a financial information and settlement system, as well as to a document management system, in an overall user-friendly electronic environment.

### OBJECTS OF THE INVENTION

It is an object of the invention to provide a travel agent and a travel settlement entity convenient and secure access to make desired settlement transactions using a user-friendly interface in a convenient and secure manner.

It is another object of the invention to provide a user-friendly system that permits an administrator to visualize user information for multiple users simultaneously and that permits flexibility in managing user access rights.

It is another object of the invention to provide a travel agent, the travel settlement entity and the validating travel carrier an ability to search for a travel transaction record and its supporting documentation in an overall user-friendly electronic environment.

### SUMMARY OF THE INVENTION

According to one exemplary embodiment, computer-implemented method of communicating transaction data relating to settlement of travel transactions that utilizes a graphical user interface having a hierarchy of graphical interface pages is provided. The method comprises receiving, with a second computer system, a first communication from a first computer system via a network, wherein the first computer system is operated by a travel agency and wherein the second computer system is operated by a travel settlement entity, wherein the first communication from the first computer system communicates a travel transaction, and wherein the first communication is based upon information entered by a user of the first computer system using the graphical user interface. The method also comprises retrieving, with the second computer system, data from a database, wherein the data correspond to the travel transaction. The method also comprises processing the data corresponding to the financial transaction using the second computer system operated by the travel settlement entity. The method also comprises sending a second communication from the second computer system to the first computer system based upon the processed data.

According to another exemplary embodiment, a computer system for communicating transaction data relating to settlement of travel transactions is provided. The computer system comprises a memory, a processing unit, and computer readable program code stored on the memory. The computer readable program code comprises instructions for causing a processing unit to execute the above-noted method.

According to another exemplary embodiment, a graphical user interface for accessing transaction data relating to settlement of travel transactions is provided. The graphical user interface comprises a plurality of graphical interface pages arranged in a hierarchical format adapted such that clicking with a computer mouse permits navigation between the graphical interface pages. At least one graphical interface page is adapted to permit a user of a computer system operated by a travel agency to enter data corresponding to a travel transaction by clicking one or more data fields using a computer mouse and typing appropriate data entries. At least another graphical interface page is adapted to display user access rights for multiple users of the computer system operated by the travel agency simultaneously. At least a further graphical interface page is adapted to enable an administrator of the computer system operated by the travel agency to add, modify or delete user access rights by clicking one or more appropriate data fields displayed on a screen using the computer mouse.

According to another exemplary aspect, a computer readable carrier comprising computer program code is provided. The computer readable carrier is adapted to cause a processing unit to display a graphical user interface for entering information corresponding to transaction data relating to settlement of travel transactions, wherein the graphical user interface comprises a plurality of graphical interface pages arranged in a hierarchical format adapted such that clicking with a computer mouse permits navigation between the graphical interface pages. At least one graphical interface page is adapted to permit a user of a computer system operated by a travel agency to enter data corresponding to a travel transaction by clicking one or more data fields using a computer mouse and typing appropriate data entries. At least another graphical interface page is adapted to display user access rights for multiple users of the computer system operated by the travel agency simultaneously. At least a further graphical interface page is adapted to enable an administrator of the computer system operated by the travel agency to add, modify or delete user access rights by clicking one or more appropriate data fields displayed on a screen using the computer mouse. The computer readable carrier is also adapted to cause the processing unit to communicate the information corresponding to the travel transaction from the computer system of the travel agency to a computer system of a travel settlement entity via a network.

According to another aspect an image of a document supporting a travel transaction record can be retrieved via a link in the graphical user interface that provides access to a document management system. A server computer system communicates with a database that hosts the raw data of numerous travel transaction records and from which summaries of travel transaction records are created. Moreover, the raw data in the database provides the server computer with data to create a document image of the documents supporting the travel transaction record. Software on the server computer system includes code for facilitating the communication between the database, which hosts the raw data of the travel transaction records and the supporting documents, and the requesting client computer system. That software not only facilitates communication but also dynamically creates the travel transaction records and document images of the supporting documents using the raw data stored on the database.

As a result, a user of a client computer system can search via a network, such as the Internet, for a travel transaction record remotely located on a database hosted by a travel settlement entity (e.g., ARC). Upon locating the particular transaction record in which the user is interested in viewing, raw data can be retrieved from the database relating to that transaction record, and a summary of the transaction record can be dynamically created. By retrieving the raw data, a document image of the documents supporting the travel transaction record can also be dynamically created. Once the client computer system creates the document image of the travel document, the user of the client computer system may view it on the computer's display and/or print the document on a local printer, thereby providing ARC, travel agencies, and travel carriers convenient access to the documents supporting the transaction records.

By using the raw data to create document images of the travel document, a document image of the travel document does not have to be stored. Rather, only the raw data from the travel document is stored on the database. And storing the raw data consumes less memory than storing the document image of the travel document from which the raw data is obtained.

Furthermore, storing the raw data in a central repository controlled by ARC maintains security and integrity of the data. That is, all reports, transaction records and travel documents are created from the same data, regardless of who requests the report, transaction record and/or travel document. Because the travel agencies and ARC will use the same data to generate their respective transaction records and travel documents, any discrepancies among the parties can be resolved by relying on the same set of common data.

The foregoing features and advantages of the present invention will become more apparent in light of the following detailed description of exemplary embodiments thereof as illustrated in the accompanying drawings.

### BRIEF DESCRIPTION OF DRAWINGS

FIG. 1 is a block diagram of a network based system for accessing and communicating transaction data relating to settlement of travel transactions.

FIG. 2 is a block diagram of a computer system for use in the network based system.

FIG. 3 is flow diagram of an exemplary method for communicating transaction data relating to settlement of travel transactions.

FIG. 4 is an input screen 400 for a document management system according to one embodiment.

FIG. 5 is a response screen 500 for a document management system illustrating a summary of a travel transaction record that includes four documents according to one embodiment.

FIG. 6 illustrates a document image 600 of a document overlaying the response screen 500, wherein the document image corresponds to one item in the summary of the travel transaction record listed in the response screen 500.

FIG. 7 shows an exemplary graphical user interface page that provides access to a financial information and settlement system and that provides a link to a document management system according to an exemplary aspect of the invention.

FIG. 8 shows an exemplary graphical user interface page according to an exemplary aspect of the invention.

FIG. 9 shows an exemplary graphical user interface page according to an exemplary aspect of the invention.

FIG. 10 shows an exemplary graphical user interface page according to an exemplary aspect of the invention.

FIG. 11 shows an exemplary graphical user interface page according to an exemplary aspect of the invention.

FIG. 12 shows an exemplary graphical user interface page according to an exemplary aspect of the invention.

FIG. 13 shows an exemplary graphical user interface page according to an exemplary aspect of the invention.

FIG. 14 shows an exemplary graphical user interface page according to an exemplary aspect of the invention.

FIG. 15 shows an exemplary graphical user interface page according to an exemplary aspect of the invention.

FIG. 16 shows an exemplary graphical user interface page according to an exemplary aspect of the invention.

FIG. 17 shows an exemplary graphical user interface page according to an exemplary aspect of the invention.

FIG. 18 shows an exemplary graphical user interface page according to an exemplary aspect of the invention.

FIG. 19 shows an exemplary graphical user interface page according to an exemplary aspect of the invention.

FIG. 20 shows an exemplary graphical user interface page according to an exemplary aspect of the invention.

### DESCRIPTION OF THE PREFERRED EMBODIMENTS

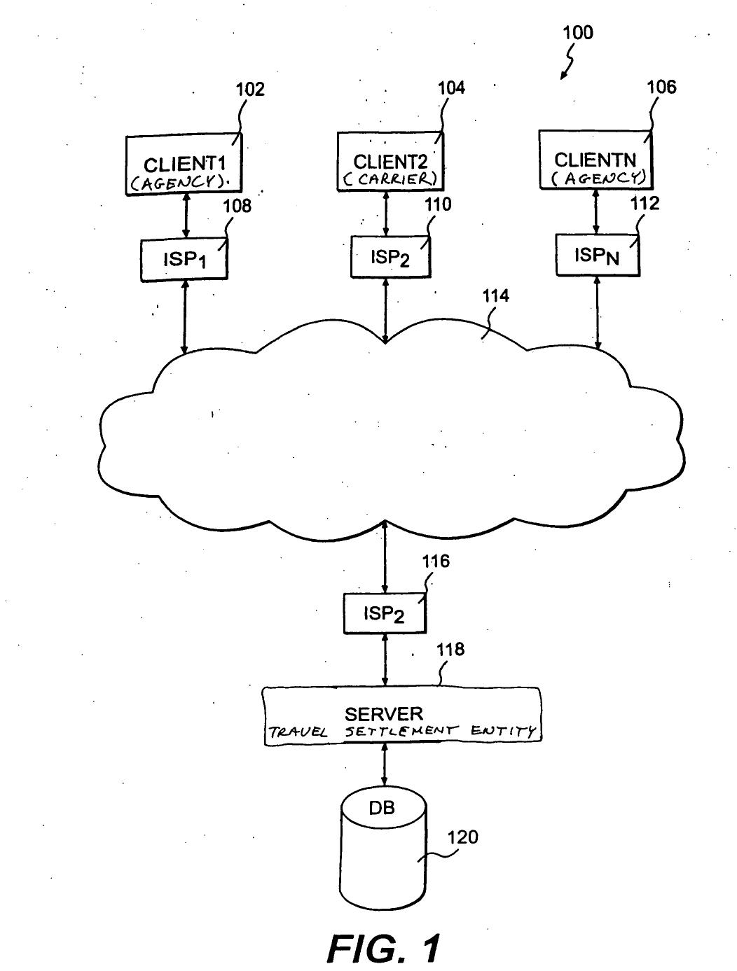

Referring to FIG. 1, there is shown a block diagram of an exemplary network based system 100 for accessing and communicating financial transaction data between a travel settlement entity and travel agencies, and which also allows these entities as well as travel carriers to electronically access travel documents. The network based system 100 can be a client-server model. That is, computer systems 102, 104, 106 each comprising, for example, a single computer, such as a personal computer, or a group of networked computers, are located at the travel agency's premises or a travel carrier's premises and can operate as client computers. A computer system 118 is located at a travel settlement entity (e.g., ARC) or some location controlled by the travel settlement entity and can operate as a server computer. Each computer system 102, 104, 106 is coupled to a computer network 114 through a communication channel (not shown) which, in turn, is connected to an internet service provider (ISP) 108, 110, 112. The computer system 118 is also coupled to the computer network 114 via an ISP 116. Computer systems 102, 104 and 106 may be referred to hereinafter as client computer systems, and computer system 118 may be referred to hereinafter as a server computer system for ease of description, but the system 100 is not limited to this example.

The computer network 114 may be the Internet, the World Wide Web or some other network of computers, such as an Intranet. The Internet is a global network of millions of computers, and the World Wide Web is a system of Internet servers (e.g., computers) that support specifically formatted documents. The documents supported by the World Wide Web are typically formatted in a script called Hyper Text Markup Language (“HTML”), which supports links to such documents.

The database 120 hosts data for numerous travel transaction records. The database 120 includes data relating to financial settlement of travel transactions and data from which summaries of travel transaction records can be created. Moreover, the data in the database 120 can provide the server computer system 118 with data to create a document image of the documents supporting the travel transaction record, as will be discuss later.

Although the remainder of the specification will discuss the operation between a first computer system (e.g., 102) a second computer system (118), it shall be understood that the methods and systems described herein are not limited to operating with only two client computers. Rather, the scope of the present invention can include simultaneous communication between the server computer system 118 and multiple client computer systems 102, 104, 106 (i.e., 1 to n).

Any one of the client computer systems may be used by a travel agent or personnel of the travel settlement entity (e.g., ARC) to access a financial information and settlement system operated by the travel settlement entity. The financial information and settlement system can be implemented on the computer system 118 with software including graphical user interface (GUI) pages, firmware, or a combination thereof. For example, both travel agents and personnel of the travel settlement entity may be able to “log on” to (i.e., access) the financial information and settlement system operated by the travel settlement entity. A travel carrier may not have such access. Rather, a travel carrier, may be able to access a document management system operated by the travel settlement entity. A travel agent and the travel settlement entity can also access the document management system. As will be described below, a financial information and settlement system (e.g., IAR Version 2.0 or “IAR 2.0”) and a document management system (e.g., ARC COMPASS™) can be accessed, for example, by clicking appropriate links from a starting page of an overall graphical user interface graphical user interface (GUI) pages, firmware, or a combination thereof.

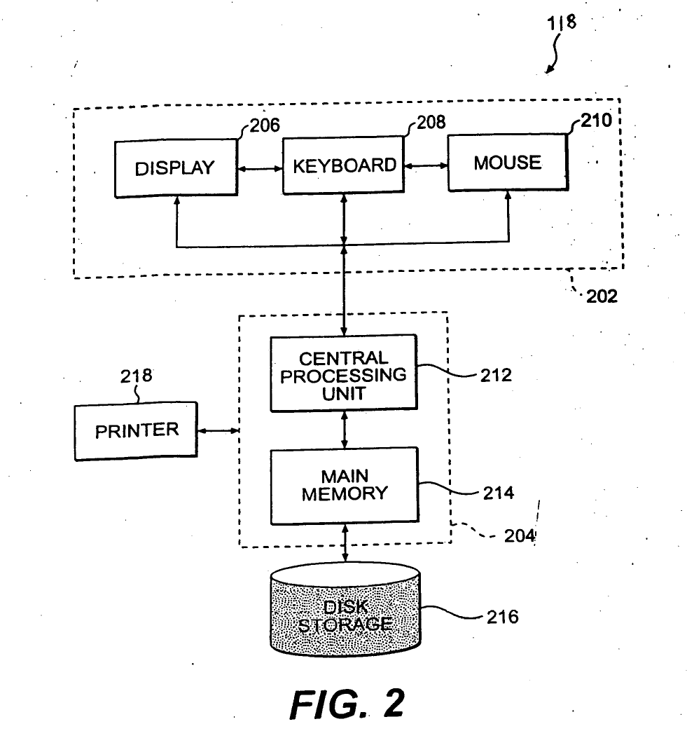

According to an exemplary embodiment, a computer system for communicating transaction data relating to settlement of travel transactions is provided. FIG. 2 illustrates an exemplary computer system 118 comprising a central processing unit (CPU) 212, such as a 486-type microprocessor or any other suitable processing unit(s), and a memory 214 which is coupled to the central processing unit 212. The computer system 118 also comprises an input/output (I/O) system 202, which may include a display 206, a keyboard 208 and a mouse 210. Although it is not shown, the computer system 118 also comprises conventional hardware, such as a modem or a serial port, for communicating (e.g., connecting) with the network 114. The computer system 118 may also optionally include an auxiliary disk storage unit 216 if additional memory is required. Furthermore, the computer system 118 may be connected to a printer 218, which allows a user to print images or documents that are viewable on the display 206.

Although it is not shown, the computer system 118 also comprises software (i.e., computer readable program code), which is typically stored in the main memory 214 or disk storage unit 216. The software may include an operating system, such as Microsoft Windows, a web browser such as Microsoft's Internet Explorer or Netscape Navigator, and other conventional routines for facilitating the display and communication of data to and from the network 114.

The computer system 118 includes hardware, such as a central processing unit, a main memory and communications hardware, similar to the client computer system 102. However, the hardware of the server computer is typically larger and more powerful than that of the client computer systems. The server computer system 118 also incorporates conventional server software for communicating to and from the network 114. Furthermore, the server computer system 118 incorporates software (i.e., code) that allows it to communicate with a database 120. Software for communicating information to the client computer systems 102, 104 and 106 can be incorporated in the server computer system 118, and additional software to facilitate such communication can be incorporated into the client computer systems (e.g., as JAVA routines). Thus, the software, the central processing unit, which executes the code, and the communications hardware (if necessary) provide the server computer system 118 with the means for performing the steps of receiving and sending the information to and from the client computer system 102 and the database 120.

Client computer systems 102, 104 and 106 may be configured like the computer system 118 as shown in FIG. 2.

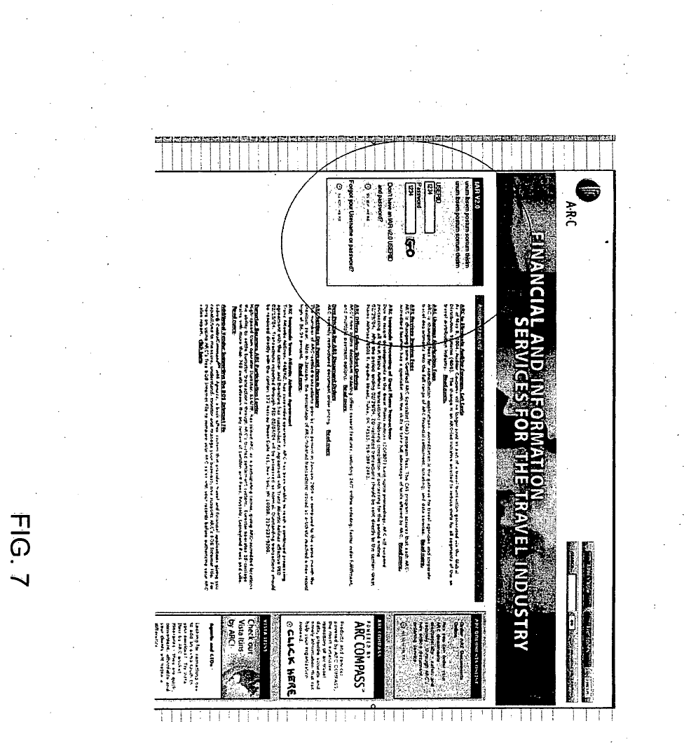

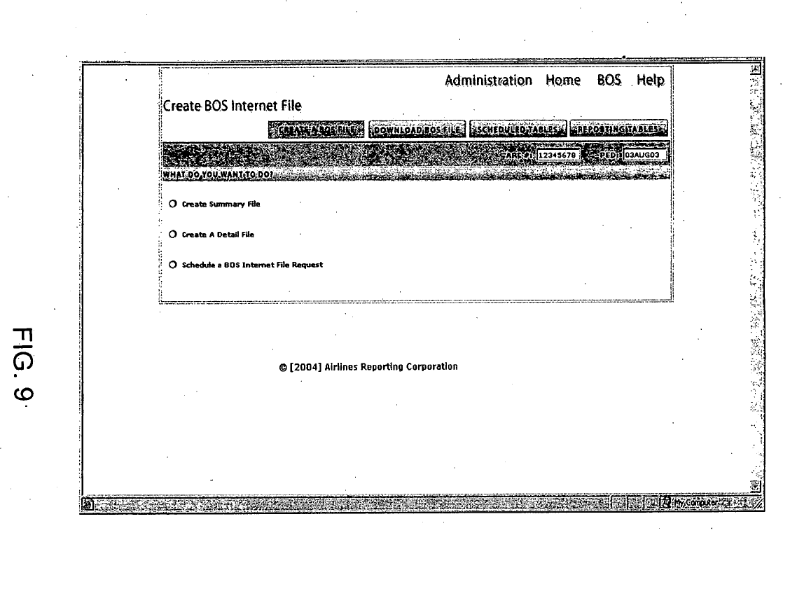

Communication can be established between the client computer system 102 and the server computer system 118 by accessing an appropriate web page (e.g., home page) of server computer system via the World Wide Web, such as shown in the example of FIG. 9. Such a home page can include a hypertext link or graphical screen button which, when clicked, directs the user to appropriate GUI pages, such as a login page, for accessing the financial information and settlement system (e.g., IAR 2.0), which provides access to transaction data relating to settlement of travel transactions. Alternatively, an appropriate login section for this aspect can be placed directly on the home page such as shown in the circled section in FIG. 7.

The home page can also include a hypertext link or graphical screen button which, when clicked, directs the user to other appropriate GUI pages for accessing the document management system (e.g., ARC COMPASS™), which provides access to document data including images of supporting documents. For instance, as shown in the example of FIG. 7, a user can access the document management system by clicking the “CLICK HERE” text under “ARC COMPASS™”.

A discussion of an exemplary GUI for accessing transaction data relating to settlement of travel transactions will now be described, and a discussion of exemplary GUI pages for accessing document data including images of supporting documents will follow. It will be understood that both of the above-noted aspects (accessing transaction data relating to settlement of travel transactions and accessing document data including images of supporting documents) can exist within an overall GUI system that permits access to both aspects.

From an appropriate home page of an overall GUI system provided by the server computer system 118, and displayed on a screen of a client computer system 102, a user of the client computer system 102 can access the financial information and settlement system that permits gaining access to transaction data relating to settlement of travel transactions. For example, as shown in FIG. 7, the user can enter a username (or USERID) and a password in a login section of a main home page, such as illustrated by the circled portion in FIG. 7. Alternatively, the user may request a login page by clicking an appropriate link or by typing (e.g., entering) an appropriate uniform resource locator (URL) address into the client computer system's 102 web browser to request a login page, which sends the request for the login page to the server computer system 118 via the network 114 and ISPs 108, 116. Upon receiving the request, the server computer system 118 can send, via the network 114, to the client computer system 102, an appropriate login screen. Also, the home page of the overall GUI system can contain a link to a document management system, such as shown in the example of FIG. 7 by the link “CLICK HERE” under “ARC COMPASS™”. Access to the document management system will be described later.

Access to the financial information and settlement system can be obtained by typing a username and password into the appropriate fields. The username is typically a six to eight alphanumeric character identifier assigned to an individual user within the corresponding travel agency. The password is typically a unique combination of at least eight characters and/or numbers associated with the username.

After entering the requested access codes, the user clicks the “Login” or “Go” button, thereby instructing the web browser on the client computer system 102 to send the login information to the server computer system 118. The server computer system 118 validates the login information by comparing the entered login information to valid login information in a look-up table stored in the server's memory or an auxiliary database (not shown). If any of the login information does not match the valid login information, the server computer system 118 may send to the client computer system 102 a screen requesting the user to reenter the login information. The server computer system 118 may include additional security measures, such as requiring the user to change her password after a certain number of days. Thus, depending upon when the user last changed her password, the server computer system 118 may send to the user a screen requesting the user to change her password. Moreover, all messages between the client computer system 102 and the server computer system 118 can be encrypted using conventional encryption technology.

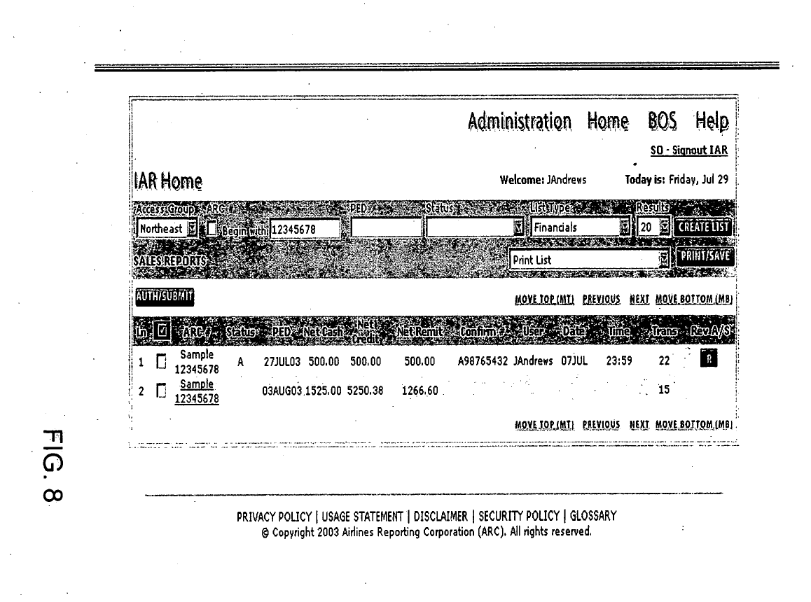

Assuming the server computer system 118 validates the access codes entered by the user, the server computer system 118 then sends to the client computer system 102 a starting screen such as the GUI screen illustrated in FIG. 8 with the heading “IAR Home”. From there the user can navigate to various screens that permit creation and downloading of desired reports relating to financial travel information, e.g., referred to as “BOS Files” (Back Office System) in the example of FIG. 9. The user can also access various tables relating to financial travel information, referred to as “Scheduled Tables” and “Report Tables” in the example of FIG. 9.

As evident in the examples of FIGS. 8 and 9, one type of information that a user may be required to enter is an organization number (referred to as an “ARC #” in these examples). An organization number is a unique identifier assigned to a travel agency by the travel settlement entity (e.g., ARC) at the time the travel agency receives accreditation (e.g., by ARC). An organization number includes a predetermined number of digits (in these examples, the ARC number includes eight digits). Thus, searching by an organization number allows an authorized user to view appropriate information associated with a specific travel agency and, if desired, within a particular timeframe.

Another type of information that a user may be required to submit is a document number, such as a ticket number. The document number includes a predetermined number of digits (e.g., 10 digits). And, as discussed above, a ticket is one type of document.

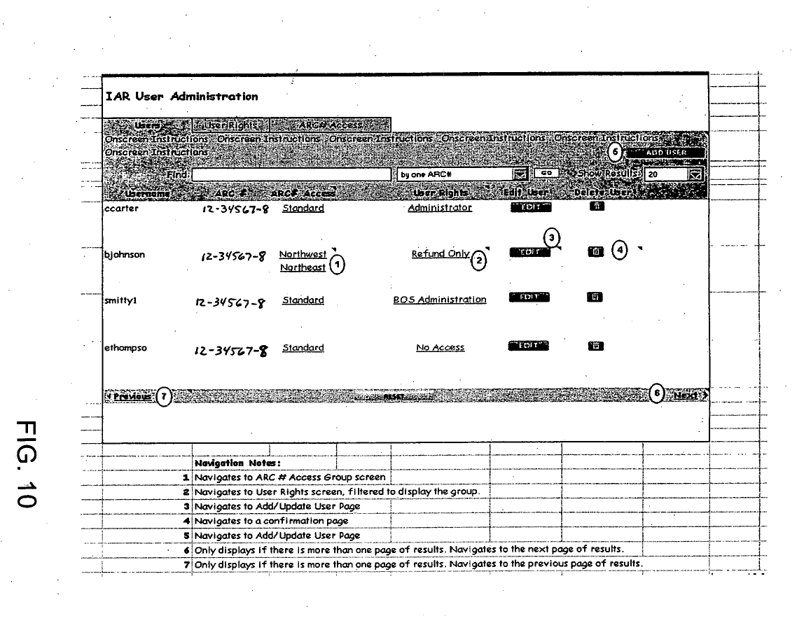

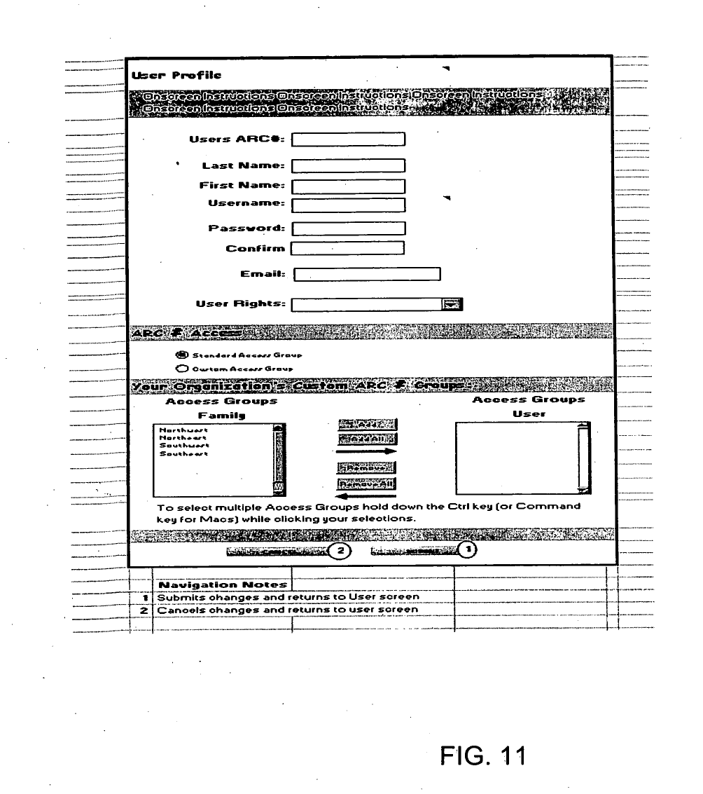

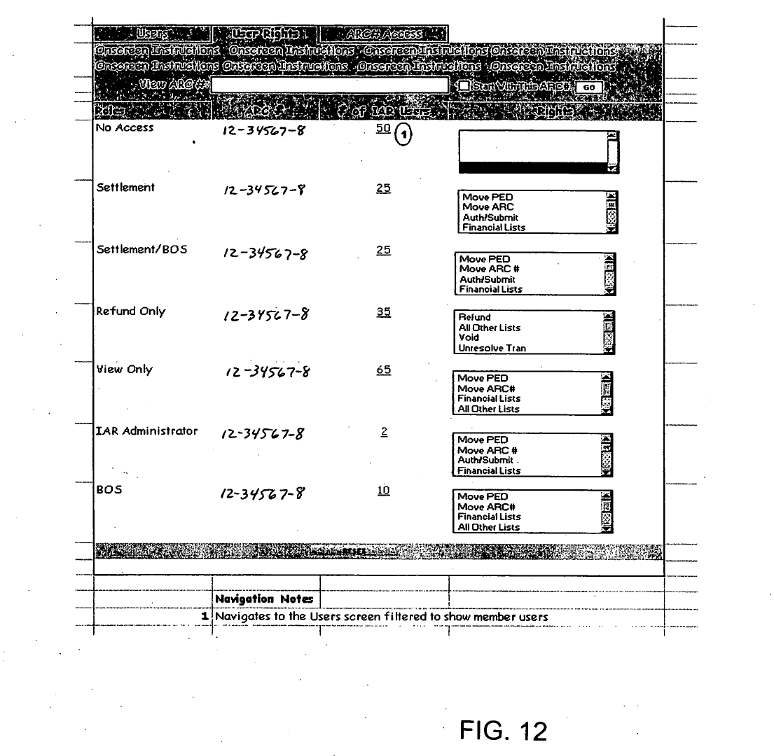

The GUI also permits convenient and flexible management of users for the travel agency's computer system and the computer system of the travel settlement entity (e.g., server system). User management can be accessed by clicking on “Administration” in the example of FIG. 8. Doing so can display a page that allows, for example, managing user profiles by adding, deleting, activating or inactivating users, such as illustrated by the page tabbed “IAR USERS” in the example of FIG. 10. As shown in this example page, the GUI can be adapted to display user access rights of multiple users of the first computer system simultaneously and can contain links for editing those rights. With this page and associated pages, such as illustrated in FIG. 11, new users can be added, and users can be assigned (or reassigned) to specific organization number access groups or user roles. Existing user profiles can be managed, passwords can be reset, access rights can be modified, and user groups can be created. Also, as illustrated by the page tabbed “User Rights” in the example of FIG. 12, a list of user roles and user rights can be viewed simultaneously for multiple users associated with a given organization number (referred to as ARC# in this example) along with the number of user members for the organization number.

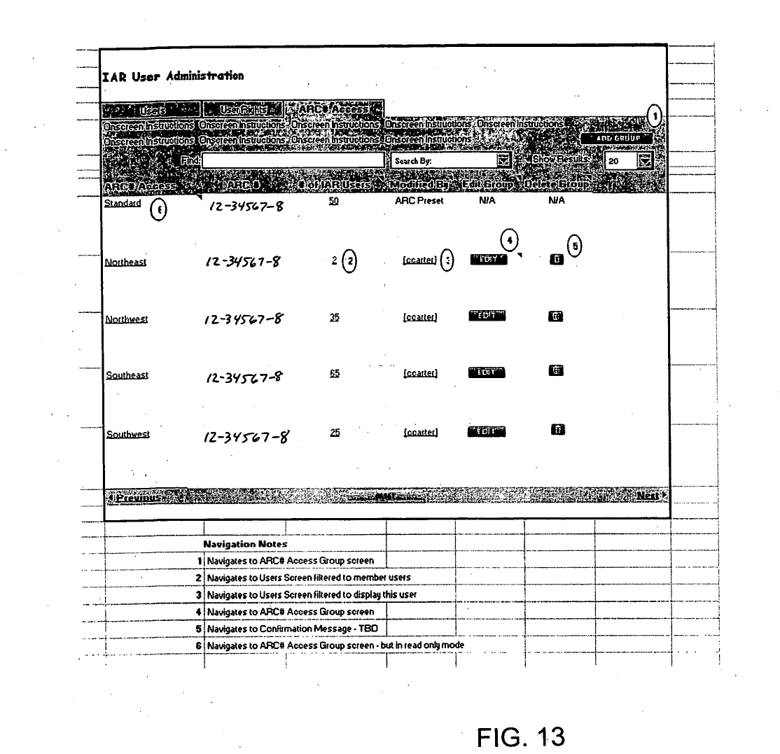

Further, rights can be granted to users without regard to an organizational hierarchy. Thus, users are not necessarily limited to accessing their own sales reports/other documents and those of offices below them in a hierarchy, for example. Rather, if users have the appropriate system rights, they can view sales reports, for example, of peers or offices above them in the organizational hierarchy. Moreover, as illustrated in the example of FIG. 13, customized, manageable location groups within an organization number umbrella can be created, and access can be granted or restricted to multiple locations for specific users.

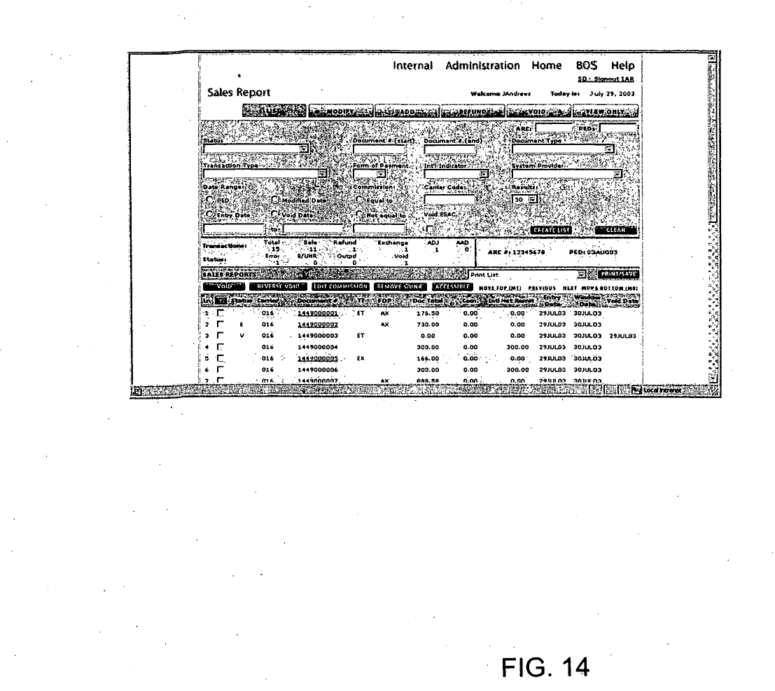

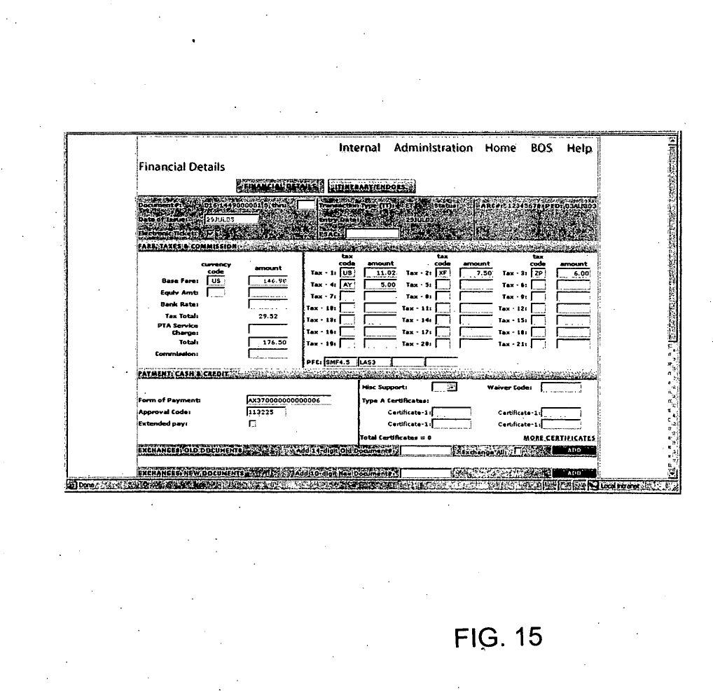

At the “IAR Home” page shown in FIG. 8, a user can input an ARC number and other information into fields (e.g., Period End Date referred to as PED, List Type such as “Financials”, etc.) and click “CREATE LIST” to create a resulting list of information, such as shown in the bottom portion of FIG. 8. Clicking on one of the line entries of the list brings up a GUI page as shown in FIG. 14, labeled “Sales Report”. This screen has various tabs such as “LIST” (for list transactions), “MODIFY” (for modifying transactions), “ADD” (for adding a new transaction), “REFUND” (for processing a refund), “VOID” (for voiding or un-voiding a transaction), and “VIEW ONLY” (for viewing financial information). By inputting various types of information into the fields shown in the upper portion of FIG. 14 (e.g., Document # start, Document # end, etc.) and clicking “CREATE LIST”, a list of sales reports can be generated as shown in the bottom portion of FIG. 14. By clicking one of the document numbers (e.g., ticket numbers) of the list, a page of financial details about that document number can be viewed, such as illustrated in FIG. 15. In addition, an itinerary for that document number can be viewed clicking on the “ITINERARY/ENDORS.” tab illustrated in FIG. 15.

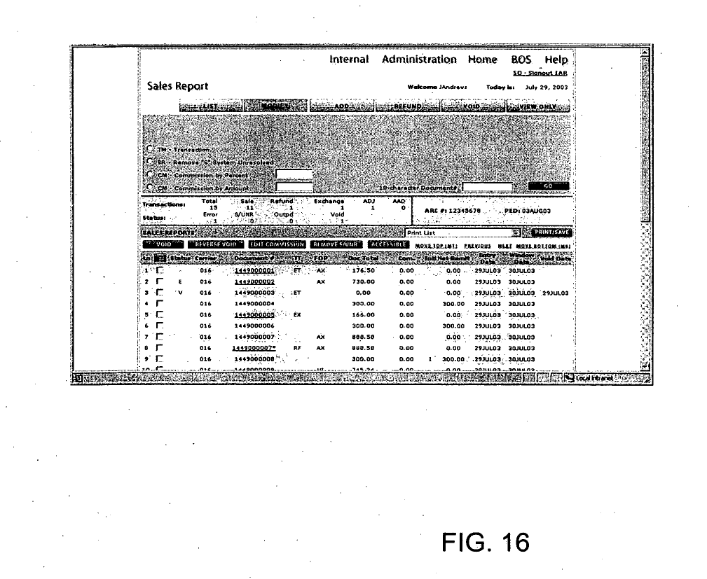

A transaction can be modified by clicking on the “MODIFY” tab shown in FIG. 14, and doing so brings up a page illustrated in FIG. 16. For example, a user can modify a commission by selecting an either “Commission by Percent” or “Commission by Amount”, inputting the appropriate information in the document number field, and clicking “GO”.

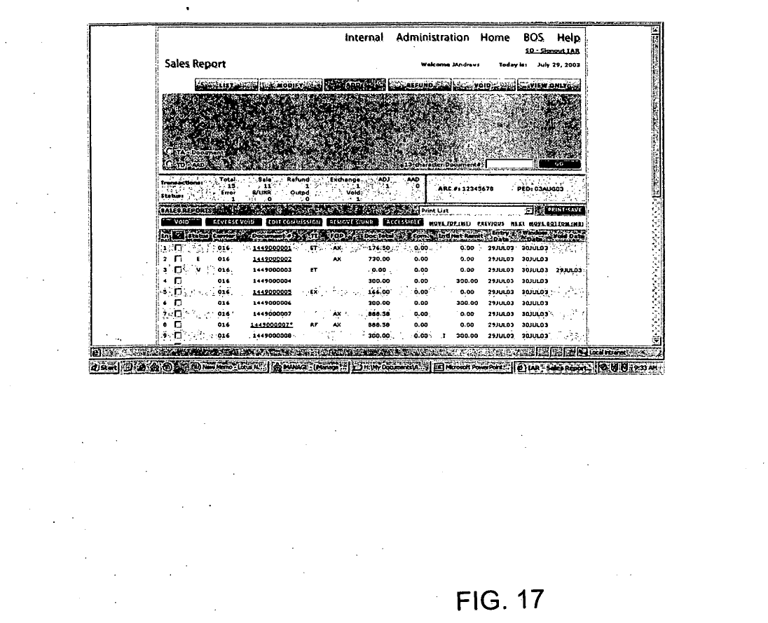

A new transaction can be added by clicking on the “ADD” tab shown in FIG. 14, and doing so brings up a page illustrated in FIG. 17. For example, a user can add a document to a list or can process an automated deduction (“AAD” for “agent automated deduction”) by selecting the appropriate field in the upper portion of the screen shown in FIG. 17, inputting the appropriate information in the document number field, and clicking “GO”.

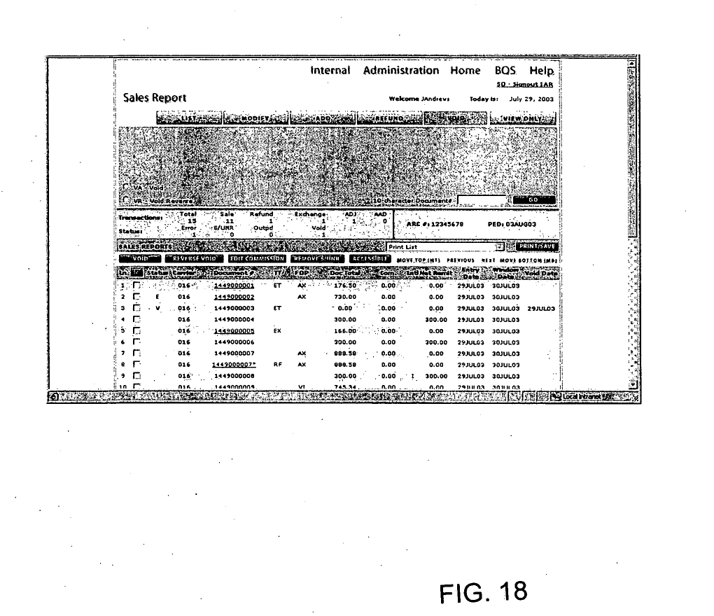

A transaction can be voided (or un-voided) by clicking on the “VOID” tab shown in FIG. 14, and doing so brings up a page illustrated in FIG. 18. For example, a user can void a transaction or reverse a void by selecting the appropriate field in the upper portion of the screen shown in FIG. 18, inputting the appropriate information in the document number field, and clicking “GO”.

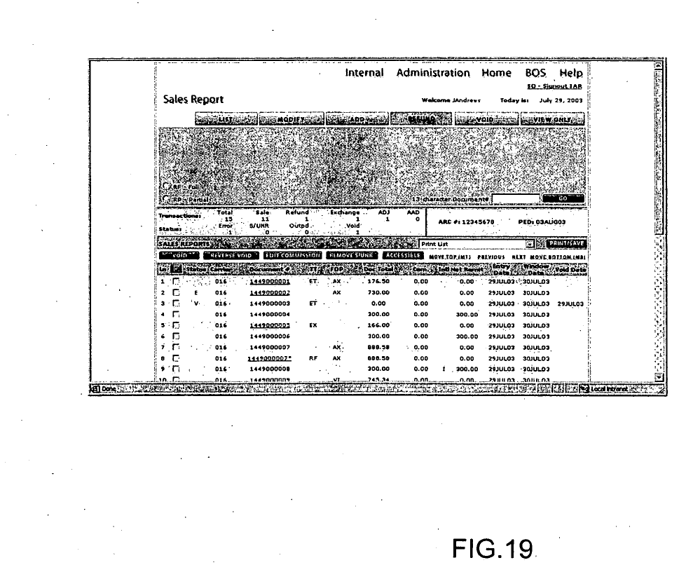

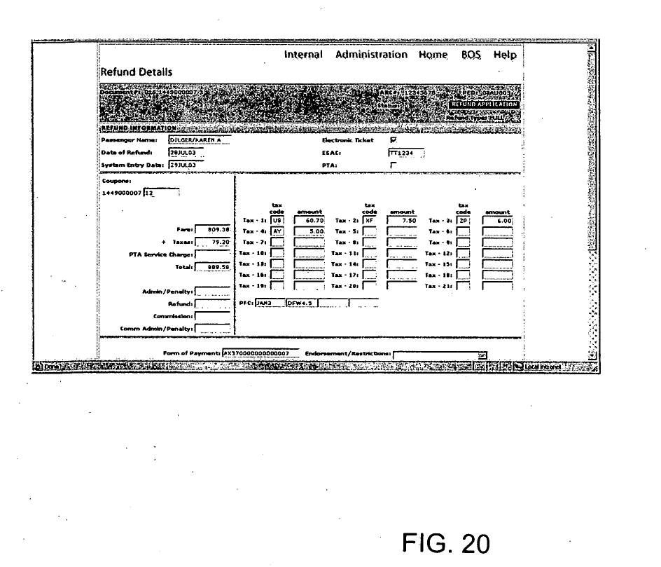

A refund can be processed by clicking on the “REFUND” tab shown in FIG. 14, and doing so brings up a page illustrated in FIG. 19. For example, a user can process a full refund or a partial refund by selecting the appropriate field in the upper portion of the screen shown in FIG. 18, inputting the appropriate information in the document number field, and clicking “GO”. Doing so causes an appropriate page to be displayed which allows the user to view “Refund Details” and make appropriate changes, such as shown in FIG. 20.

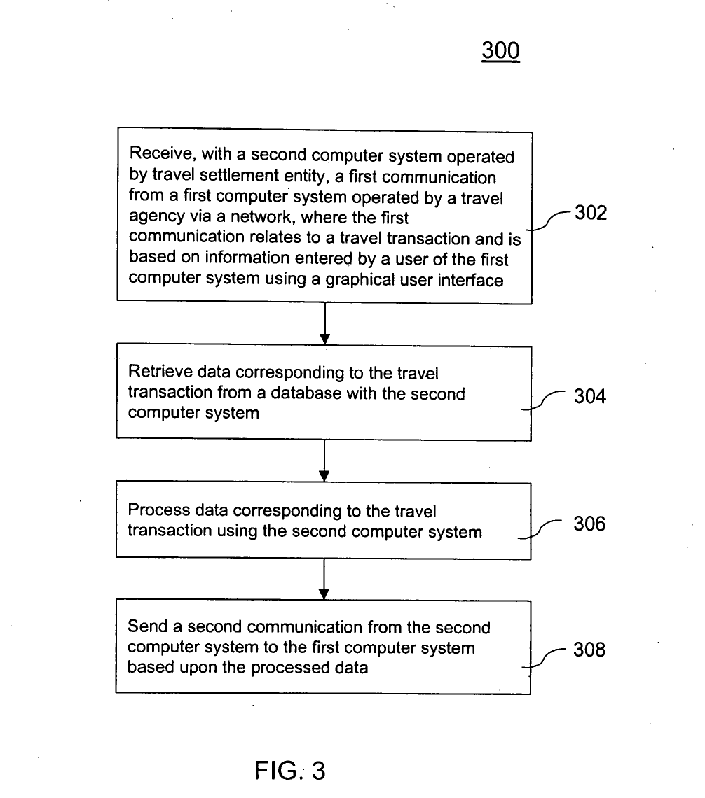

The computer system 118 (second computer system) includes computer readable program code stored in memory 214 or 216 comprising instructions adapted to cause the processing unit 212 to execute the method 300 illustrated in FIG. 3. Among other things, the program code causes a graphical user interface (GUI) to be displayed on a display screen to a user. The GUI comprises a hierarchy of graphical interface pages that may be displayed on a display screen, for example, by appropriate clicking with a computer mouse. Thus, a user can navigate between the various GUI screens (also called pages) using appropriate mouse clicks. Exemplary pages of the GUI will be described below.

As shown in FIG. 3 at step 302, the method 300 comprises receiving, with a second computer system (e.g., computer system 118), a first communication from a first computer system (e.g., computer system 102) via a network (e.g., network 114), wherein the first computer system is operated by a travel agency and wherein the second computer system is operated by a travel settlement entity. The first communication from the first computer system 102 communicates a travel transaction, wherein the first communication is based upon information entered by a user of the first computer system 102 using the GUI.

The travel transaction can be any of a variety of travel transactions, including but not limited to: addition of a new transaction, modification of an existing transaction, request of a refund, and void of an existing transaction (see, e.g., FIGS. 16, 17, 18 and 19). For example, the travel transaction can be a request of a partial refund from the travel carrier based on a change in a travelers itinerary. In such a case, a user of the travel agency's computer system can click the “REFUND” tab after navigating to an appropriate GUI page, can input a document number (e.g., ticket number) in the appropriate field, and can click “GO” (e.g., FIG. 19). This information is then sent from the first computer system 102 to the second computer system 118 of the travel settlement entity, which receives the information via the network 114.

As shown at step 304, the method 300 also comprises retrieving, with the second computer system 118, data from a database 120, wherein the data correspond to the travel transaction. For example, with regard to the partial refund referred to above, the second computer system 118 can retrieve the travel transaction record from the database 120 based upon the ticket number provided, and can then send the travel record back to the first computer system 102 of the travel agency, wherein the travel record is then displayed on a screen page of the GUI. The user of the first computer system 102 at the travel agency can then update the data fields of the travel record as appropriate using the GUI, and this information can then be sent back to the second computer system 118 of the travel settlement entity.

As shown at step 306, the method 300 also comprises processing the data corresponding to the financial transaction using the second computer system 118 operated by the travel settlement entity. For instance, with regard to partial refund example, the second computer system 118 can verify that all necessary data fields have been filled out and can create an electronic receipt for the travel agency.

As shown at step 308, the method 300 also comprises sending a second communication from the second computer system 118 of the travel settlement entity to the first computer system 102 of the travel agency based upon the processed data. For instance, with regard to the partial refund example, the second computer system 118 can send the electronic receipt that was generated to the first computer system 102 of the travel agency.

As noted above, the computer systems described herein may be single computers, such as personal computers, or may be groups of networked computers. Thus, when a given computer system receives a communication, that communication may be received by any suitable computer of that computer system. When that computer system sends a communication, that communication may be sent by any suitable computer of that computer system. Thus, it is not necessary for a given computer system to send and receive communications with the same computer of the computer system.

The GUI referred to above can be adapted such that the first computer system operated by the travel agency and the second computer system operated by the travel settlement entity can access a same version of the GUI using their respective computer systems. Commonality in the GUI platform between different types of users can facilitate both use of the system and troubleshooting.

Thus, it will be appreciated that, according to an exemplary embodiment, a graphical user interface for accessing transaction data relating to settlement of travel transactions comprises a plurality of graphical interface pages arranged in a hierarchical format adapted such that clicking with a computer mouse permits navigation between the graphical interface pages. At least one graphical interface page is adapted to permit a user of a computer system operated by a travel agency to enter data corresponding to a travel transaction by clicking one or more data fields using a computer mouse and typing appropriate data entries. At least another graphical interface page is adapted to display user access rights for multiple users of the computer system operated by the travel agency simultaneously. At least a further graphical interface page is adapted to enable an administrator of the computer system operated by the travel agency to add, modify or delete user access rights by clicking one or more appropriate data fields displayed on a screen using the computer mouse.

Moreover, according to another aspect, any form of computer readable carrier can contain processing instructions adapted to a cause a processing unit to execute the methods described herein. The computer readable carrier can be any suitable type of medium or modulated wave/signal, such as solid-state memory (e.g., read only memory (ROM), random access memory (RAM), etc.), magnetic memory, optical memory, other type of memory, or modulated waves/signals (such as radio frequency, audio frequency, or optical frequency modulated waves/signals) containing an appropriate set of computer instructions that would cause a processing unit to carry out the techniques described herein.

Thus, it will also be appreciated that, according to another exemplary embodiment, a computer readable carrier is provided comprising computer program code adapted to cause a processing unit to execute a step of displaying a graphical user interface for entering information corresponding to transaction data relating to settlement of travel transactions, wherein the graphical user interface comprises a plurality of graphical interface pages arranged in a hierarchical format adapted such that clicking with a computer mouse permits navigation between the graphical interface pages. Of the graphical interface pages, at least one graphical interface page is adapted to permit a user of a computer system operated by a travel agency to enter data corresponding to a travel transaction by clicking one or more data fields with a computer mouse and typing appropriate data entries. Also, at least another graphical interface page is adapted to display user access rights for multiple users of the computer system operated by the travel agency simultaneously. Further, at least a further graphical interface page is adapted to enable an administrator of the computer system operated by the travel agency to add, modify or delete user access rights by clicking one or more appropriate data fields displayed on a screen with the computer mouse. The computer readable carrier is also adapted to cause a processor to execute a step of communicating the information corresponding to the travel transaction from the computer system of the travel agency to a computer system of a travel settlement entity via a network.

A discussion of an exemplary document management system that permits accessing document data including document images from a database, such as database 120, using exemplary GUI pages will now be described. As noted previously, the GUI pages of the document management system can exist within the hierarchy of an overall GUI system that also contains links to the financial information and settlement system previously described. As noted above with regard to FIG. 8, and as discussed further below, one way of accessing the document management system is from a link on the home page of the overall GUI system. However, it will be appreciated that the GUI pages of the financial information and settlement system can also provide internal links to documents and document images, i.e., there can be internal links within the financial information and settlement system that provide access to the document management system. For example, when a particular transaction associated with an organization number and document number is accessed via the financial information and settlement system, GUI pages associated with that transaction can contain links to the document management system that allow a user to view and print images of documents associated with that transaction.

According to one example, to gain access to the information stored on the database 120, a user of the client computer system 102 can navigate to a home page of the server computer system 118 and click on an appropriate link that provides a gateway to the document management system that permits accessing document data, such as described above with regard to FIG. 7 (e.g., clicking in the portion of the GUI page labeled “ARC COMPASS™”). The user can then access an appropriate login section or login page. The user can log into the system in a manner similar to that described above in connection with FIG. 7, although the particular login page or login section may be formatted differently, if desired, than that previously described. The client computer system 102 can be that of a travel carrier, a travel agency, or personnel of the travel settlement entity in this aspect.

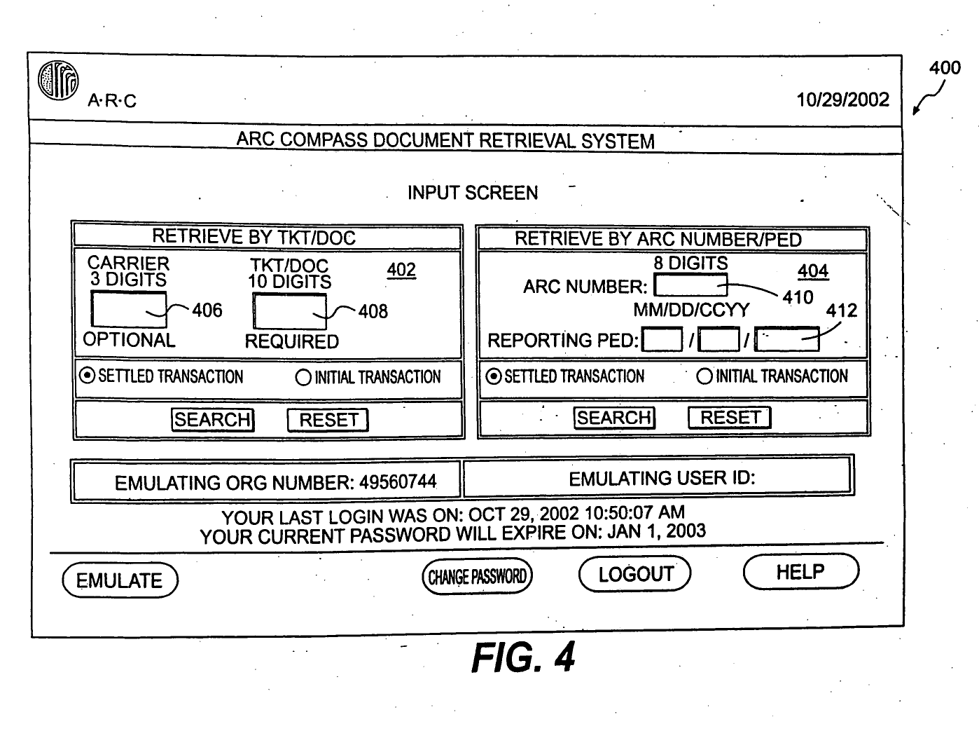

Assuming the server computer system 118 validates the access codes entered by the user, the server computer system 118 then sends to the client computer system 102 a retrieval screen, such as the GUI retrieval screen 400 illustrated in FIG. 4. The retrieval screen 400 indicates the date that the user last logged onto the automated retrieval system and the date the user's password is set to expire. Moreover, the retrieval screen 400 has two portions from which a search may be initiated. One portion 402 allows the user to search for a travel transaction record by entering a document number such as a ticket number, and the other portion 404 allows the user to search for travel transaction records by an organization number (e.g., ARC number) within a certain time period.

As also discussed above, an ARC number is a unique identifier assigned to a travel agency by ARC at the time the travel agency receives ARC accreditation. Thus, searching by an ARC number allows an authorized user to view all appropriate documents associated with a specific travel agency within a particular timeframe. For example, a travel carrier can only see documents (i.e., tickets) relating to that travel carrier (i.e., sold by that travel carrier or sold by a travel agency on behalf of that travel carrier). Similarly, a travel agency can only see documents relating to transactions of its own agency or of its subordinate agencies.

When searching for travel transaction records using the document number, a user can enter the document (e.g., ticket) number into block 408 in the corresponding portion 402 of an exemplary retrieval screen 400 of the GUI. Air carrier codes include three digits. For example, the travel carrier code for US Airways is 037. If the user incorrectly enters the document number, the user may click the “Reset” button, which will clear all of the entered data. Assuming the user correctly enters the document number, the user then clicks the “Search” button, which, instructs the web browser on the client computer system 102 to send the access codes to the server computer system 118.

When searching for travel transaction records associated with the ARC number, the user enters the ARC number into block 410 of the corresponding portion 404 of the retrieval screen 400. The user also enters the Period End Date (“PED”) into block 412. In comparison to searching for travel transaction records using a document number, searching for travel transaction records via an ARC number and a PED may increases the number of transactions records returned to the user because sending by a document number will only return the documents having the same transaction number while searching for documents with an ARC number and a PED returns all documents relating to a particular travel agency within a certain timeframe.

The PED data is entered in the following format: two digits for the month (MM); two digits for the day (DD) of the month; and four digits for the year (CCYY). If the user incorrectly enters the ARC number and/or the PED, the user may click the “Reset” button, which will clear all of the entered data. Assuming the user correctly enters the data, the user then clicks the “Search” button, which, instructs the web browser on the client computer system 102 to send the access codes to the server computer system 118.

The database 120 includes multiple travel transaction records. A travel transaction record includes at least one travel document (hereinafter “document”). A document may be one of the following: Ticket; Agent Automated Deduction (AAD); Agent Coupon (AGT); Authority to Refund a PTA transaction (ARP); Auditor Coupon (AUD); Type A certificate (CER); Companion coupon (CMP); Conjunction coupon (CNJ); Coupon returned in a refund or exchange (CPN); Credit memo (CRM); Debit memo (DBM); Carrier non-transport document (NTR); Recall Commission Statement (RCC); Refund Exchange Notice (REN); Regenerated Stock Control Number (RSN); Unapplied Void Transaction (UAV); Type B voucher (VOU); a Miscellaneous Charge Order (MCO) and other supporting documents. For example, if a customer purchases a ticket with a voucher, the voucher is treated as one document and the ticket is treated as another document. If the customer later exchanges the ticket for another ticket, then the second ticket will be treated as a third document. Moreover, each flight segment within a roundtrip ticket may be considered a separate document.

In order to track an entire transaction, which may include multiple documents, ARC assigns a common transaction number to all related documents. Thus, all related documents will have the same transaction number, and all of the related documents create a single transaction. Accordingly, a record of the transaction includes all related documents. Moreover, a summary of the travel transaction record is a summary of the documents constituting a particular transaction. Thus, the summary of the travel transaction record includes information contained in each related document.

The database 120 includes the raw data for all documents. Each document includes information, and that information, along with its transaction number, is stored as data within data elements in the database 120. The summaries of the travel transaction records and the document images of the document are dynamically created by the server computer system 118, which returns the data from the corresponding data elements of the database 120. As will be discussed in more detail below, the present invention allows a user to search for both “Settled” and “Initial” transaction data. Thus, the database 120 includes data for both settled and initial travel transaction records. The database receives its data from the CRS or the IAR upon a document being created.

A user of a client computer system 102 can search, via the network, for a travel transaction record remotely located on a database 120 hosted by the travel settlement entity. The server computer system 118 dynamically creates a summary of the travel transaction record from the data stored on the database 120. The summary includes a list of documents that constitute the travel transaction record and various information from each document. Once the server computer system 118 creates the summary of the travel transaction record, the summary is sent to the client computer system 102, where the user can view it. If she so desires, the user of the client computer system 102 may also print a copy of the summary locally using a web browser.

Furthermore, a user of client computer system 102 can request the supporting documentation that corresponds to each of the items listed on the summary of the travel transaction record. That is, a user of the client computer system 102 can retrieve a document image of the document(s) that supports the travel transaction record. If the client computer system 102 requests a document, the server computer system 118 retrieves the raw data from the database 120 corresponding to that document. The server computer system 118 then dynamically creates a document image of the document from the data retrieved from the database 120. As discussed above, there are various types of documents. And when the client computer system 102 requests a document from the server computer system 118, the server computer system 118 recognizes the type of document being requested. Upon recognizing the type of document being requested, the server computer system 118 dynamically creates a document image of a template corresponding to the type of requested document. Thus, the server computer system 118 dynamically creates a document image of a document by dynamically creating a template and inserting the retrieved data into that template. Once the server computer system 118 creates the document image of the document, the document image is sent, via the network 114, to the client computer system 102, thereby allowing the user to also view and print the supporting document(s). Accordingly, the server computer system 118 includes the appropriate software (e.g., code) and hardware to facilitate the communication (e.g., receipt and delivery) of information (e.g., data) between the client computer system 102 and the database 120.

Both search screens of the retrieval screen 400 allow the user of the client computer system 102 to search for “Settled” transaction records and “Initial” transaction records. A settled transaction record includes transaction data as processed by ARC. That is, the settled transaction record is the same as shown on the travel agency's sales report. An initial transaction record is the transaction data as it appeared in the first instance of recording by ARC. The travel agency is able to make changes to the initial transaction record before it is submitted to ARC for processing. However, after ARC processes the travel transaction record, the travel agency cannot alter the data. Nevertheless, the present invention allows a user to search for both settled and initial transaction records.

The settled and initial travel transaction records are stored in the database 120. Specifically, the data from which the travel transaction records are created is stored as data elements within the database 120. Thus, upon receiving either of the two types of requests for travel transaction records from the client computer system 102, the server computer system 118 searches the database 120 for the requested data. That is, the server computer system 118 communicates with the database 120 to determine whether that database 120 includes the requested data within its data elements. If the database 120 does not have the requested data or the user is not authorized to view such data, the server computer system 118 sends an appropriate response to the client computer system 102.

However, if the database 120 has the requested data, the server computer system 118 retrieves the data from the data elements in the database 120 and dynamically creates a summary of the travel transaction record corresponding to the request. As discussed above, ARC assigned a transaction number to each document. Thus, when the server computer system 118 receives a request for a particular document using a document number, the server computer system 118 determines the transaction number assigned to the requested document. Thereafter, the server computer system 118 retrieves a list of all documents having that same transaction number. And, as mentioned above, a summary of the travel transaction record is a summary of each document having the same transaction number (i.e., within the same transaction chain). Thus, the server computer system 120 lists certain information from each of the documents having the same transaction number. Once the server computer system 118 creates the summary of the travel transaction record, the server computer system 118 sends the summary to the client computer system 102. That is, the server computer system 118 sends the requested data to the client computer system 102 in the form of a response screen.

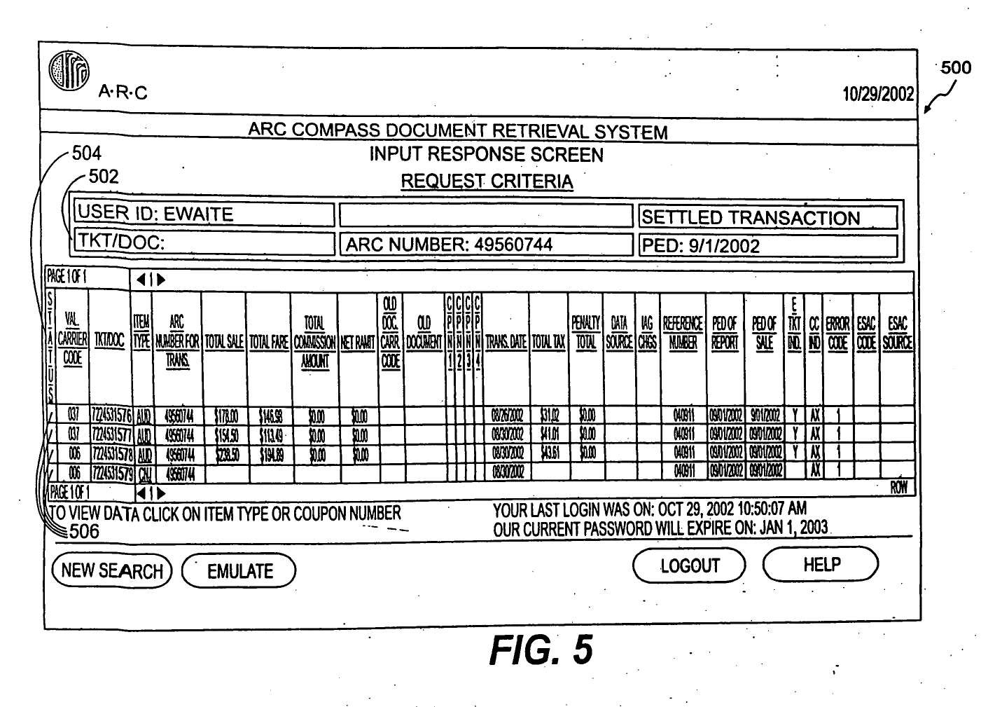

Referring to FIG. 5, there is shown an exemplary response screen 500, which the server computer system 118 would send to the client computer system 102 in reply to receiving a request for settled transaction data, wherein such request included an ARC number and a PED. As shown in FIG. 5, the response screen 500, which is a GUI, may include three sections: a search request criteria table 502; column headings 504; and lines of data summarizing information pertaining the respective documents within the travel transaction record 506. It shall be understood that a travel transaction record preferably includes the column headings 504 and the lines of data 506, but the travel transaction record may also include information the same or equivalent to that in the criteria table 502. FIG. 5 illustrates 28 column headings. However, it shall be understood that a different number of (e.g., additional) column headings may be included.

Because the user requested data by providing an ARC number and a PED, the search request criteria table 502 includes the User ID, the ARC number and the PED. FIG. 5 illustrates a single transaction that has four documents associated with that transaction. Those four documents include two audit (“AUD”) coupons and a two-part ticket-audit (“AUD”) coupon and conjunction coupon (“CNJ”). As discussed above, ARC assigns a transaction number to related documents within a chain of documents. Accordingly, when a user searches the database 120 for documents, via the server computer system 118, the server computer system 118 retrieves a list all documents associated with the same transaction number, thereby providing the user with a list summarizing all of the documents within the transaction chain. Thus, the four documents have the same transaction number, which is maintained in the database but preferably not displayed on the summary of the travel transaction record. However, it shall be understood that it is within the scope of this invention to display the transaction number on the summary of the travel transaction record if so desired.

The third section of the response screen—the lines of sales report data—may include thousands of lines of transaction information. Thus, screen breaks occur every 25 lines, thereby allowing multiple documents associated with a single transaction to appear on multiple pages. Furthermore, when 25 or more documents are retrieved, multiple response screens will be produced, and the multiple response screens will be indicated as “Page 1 of X<<1 2 3 4 5 etc.>>”.

A data field is associated with each column heading and sales report line. And some of those data fields are associated with the process to retrieve a document image and other data fields are not. The data fields associated with image documents will be referred to as “document image links” because a document image corresponding to that data (i.e., document summary) may be retrieved by clicking the respective data field. Document image links are distinguishable because they may be highlighted with a different color, underlined, or some other obvious means of distinguishing text. Clicking the data field refers to selecting a data field by pointing the cursor, via movement of the mouse, to the data field and tapping on the mouse button, thereby pressing it down and immediately releasing it.

The document image links in FIG. 5 are the data fields that have underlined text. For example, referring to FIG. 5, under the column heading “Item Type”, the data fields identified as “AUD” and “CNJ” are document image links. Thus, if the user of the client computer system 102 displays a response screen similar to either the response screen of FIG. 5, the user may request an image of the supporting document associated with the corresponding travel transaction record by clicking a document image link. By clicking the document image link, the web browser instructs the client computer system 102 to send a request to the server computer system 118 for the document image of the supporting document that corresponds to that item of the travel transaction record.

Upon receiving the request for the document image, the server computer system 118 recognizes the type of document being requested and dynamically creates a template for that type of document. For example, if the user of a client computer system 102 clicked the “AUD” in the line of the summary of the travel transaction record having “TKT/DOC” 7224531578, the server computer system 118 would recognize that the user was requesting a document image of an auditor coupon and dynamically generate a document image of an auditor coupon template.

Also, upon receiving the request for the document image, the server computer system 118 communicates with the database 120 to retrieve the data corresponding to the requested document from the data elements in the database 120. Assuming the database 120 has the requested data and the request originated from an authorized user, the server computer system 118 retrieves the data. Upon retrieving the requested data, the server computer system 118 creates a document image 600 of the document—from which the data originated—using the retrieved data and the dynamically created template. According to the example discussed above, the server computer system 118 would dynamically create a document image of an auditor's coupon corresponding to “TKT/DOC” 7224531578, which is the third item of the summary of the travel transaction record, using the dynamically created template and the retrieved data.

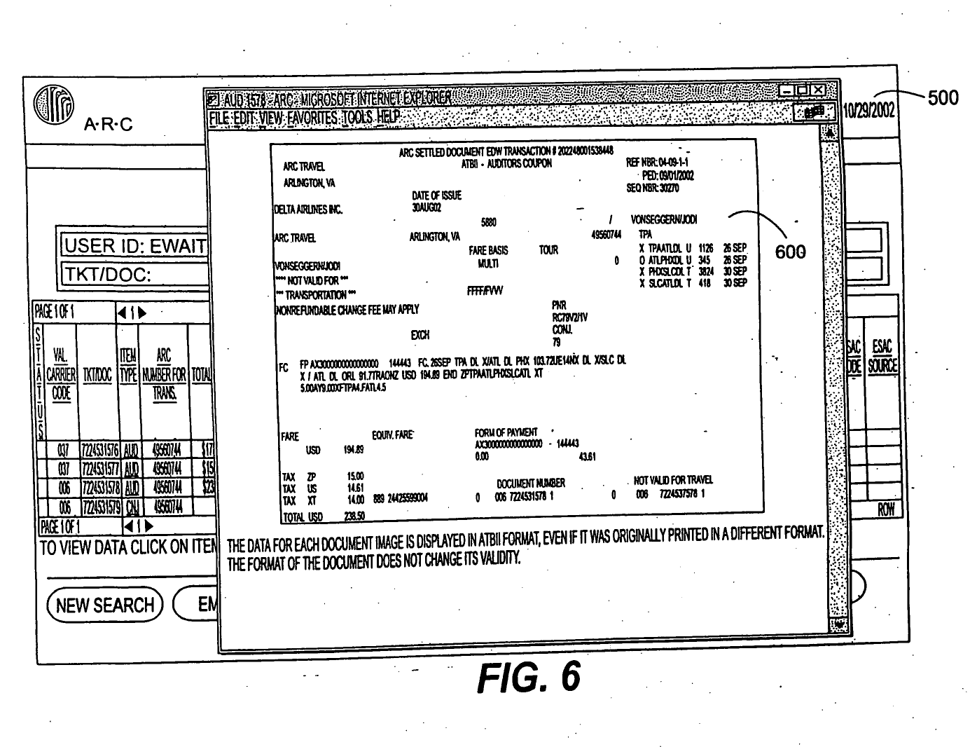

The resulting document image would be the same as or equivalent to document image 600 illustrated in FIG. 6. As illustrated on the top line of the document image 600, the travel transaction number, such as 202248001538448, is preferably included. However, it shall be understood that it is within the scope of this invention to omit the travel transaction number from the document image 600 of the document.

After creating the document image 600, the server computer system 118 sends the document image 600 to the client computer system 102. Upon receiving the document image 600, the client computer system 102 displays it over the response screen 500. Once the document image 600 is displayed on the display of the client computer system 102, the user may view and/or print (via a web browser) such image on a local printer, thereby negating the need to request a hard copy of the support document from the travel agent (or ARC), who would manually have to reproduce a photocopy of the support document and send it to the requesting party. Thus, a user of a client computer system can remotely retrieve, view, electronically forward (via e-mail) and print travel transaction records and their supporting documentation.

Although the invention has been described and illustrated with respect to the exemplary embodiments thereof, it should be understood by those skilled in the art that the foregoing and various other changes, omissions and additions may be made without departing from the spirit and scope of the invention.

What is claimed is:

1. A computer-implemented method of communicating transaction data relating to settlement of travel transactions utilizing a graphical user interface having a hierarchy of graphical interface pages, the method comprising the steps of:
(a) receiving, with a second computer system, a first communication from a first computer system via a network, wherein the first computer system is operated by a travel agency and wherein the second computer system is operated by a travel settlement entity, wherein the first communication from the first computer system communicates a travel transaction, and wherein the first communication is based upon information entered by a user of the first computer system using the graphical user interface;
(b) retrieving, with the second computer system, data from a database, wherein the data correspond to the travel transaction
(c) processing the data corresponding to the financial transaction using the second computer system operated by the travel settlement entity; and
(d) sending a second communication from the second computer system to the first computer system based upon the processed data.

2. The method of claim 1, wherein the travel transaction is selected from the group consisting of: addition of a new transaction, modification of an existing transaction, request of a refund, and void of an existing transaction.

3. The method of claim 1, wherein the graphical user interface is adapted such that the first computer system operated by the travel agency and the second computer system operated by the travel settlement entity can access a same version of the graphical user interface using their respective computer systems.

4. The method of claim 1, wherein communication is established between the first computer system and the second computer system via a login page of the graphical user interface.

5. The method of claim 1, wherein the graphical user interface is adapted to display user access rights for multiple users of the first computer system simultaneously.

6. The method of claim 1, wherein the graphical user interface is adapted to enable an administrator of the first computer system to add, modify or delete user access rights by clicking one or more appropriate data fields displayed on a screen using a computer mouse.

7. The method of claim 1, wherein the graphical user interface contains a link to a document management system that permits the travel agency and the travel settlement entity to access images of travel documents.

8. The method of claim 1, comprising receiving a search request from the first computer system.

9. The method of claim 8, wherein the search request includes a document number.

10. The method of claim 8, wherein said search request includes an organization number and a Period End Date.

11. The method of claim 1, comprising sending data for multiple travel transactions from the second computer system to the first computer system.

12. The method of claim 10, wherein the graphical user interface is adapted to display information for the multiple travel transactions on a display screen of the first computer system, and to permit selection, with the first computer system, of a displayed data field of one of the multiple travel transactions.

13. The method of claim 12, wherein graphical user interface is adapted such that the selection of the displayed data field comprises clicking the displayed data field using a computer mouse.

14. The method of claim 1, wherein said network is the Internet.

15. The method of claim 1, wherein said network is the World Wide Web.

16. A computer system for communicating transaction data relating to settlement of travel transactions, the computer system comprising:
(a) a memory;
(b) computer readable program code stored on said memory, said computer readable program code comprising instructions for:
(i) receiving, with said computer system, a first communication from another computer system via a network, wherein said another computer system is operated by a travel agency and wherein said computer system is operated by a travel settlement entity, wherein the first communication from said another computer system communicates a travel transaction, and wherein the first communication is based upon information entered by a user of said another computer system using a graphical user interface;
(ii) retrieving, with said computer system, data from a database, wherein the data correspond to the travel transaction;
(iii) processing the data corresponding to the travel transaction using said second computer system operated by the travel settlement entity; and
(iv) sending a second communication from said computer system to said another computer system based upon the processed data; and
(c) a processing unit coupled to said memory, wherein said processing unit executes said instructions of said computer readable program code.

17. A graphical user interface for accessing transaction data relating to settlement of travel transactions, the graphical user interface comprising:
a plurality of graphical interface pages arranged in a hierarchical format adapted such that clicking with a computer mouse permits navigation between the graphical interface pages, wherein:
(a) at least one graphical interface page is adapted to permit a user of a computer system operated by a travel agency to enter data corresponding to a travel transaction by clicking one or more data fields using a computer mouse and typing appropriate data entries;
(b) at least another graphical interface page is adapted to display user access rights for multiple users of the computer system operated by the travel agency simultaneously; and
(c) at least a further graphical interface page is adapted to enable an administrator of the computer system operated by the travel agency to add, modify or delete user access rights by clicking one or more appropriate data fields displayed on a screen using the computer mouse.

18. A computer readable carrier comprising computer program code adapted to cause a processing unit to execute steps of:
(a) displaying a graphical user interface for entering information corresponding to transaction data relating to settlement of travel transactions, wherein the graphical user interface comprises a plurality of graphical interface pages arranged in a hierarchical format adapted such that clicking with a computer mouse permits navigation between the graphical interface pages, wherein:
(i) at least one graphical interface page is adapted to permit a user of a computer system operated by a travel agency to enter data corresponding to a travel transaction by clicking one or more data fields using a computer mouse and typing appropriate data entries;
(ii) at least another graphical interface page is adapted to display user access rights for multiple users of the computer system operated by the travel agency simultaneously; and
(iii) at least a further graphical interface page is adapted to enable an administrator of the computer system operated by the travel agency to add, modify or delete user access rights by clicking one or more appropriate data fields displayed on a screen using the computer mouse; and
(b) communicating the information corresponding to the travel transaction from the computer system of the travel agency to a computer system of a travel settlement entity via a network.
